(19) United States
(12) Patent Application Publication
(10) Pub. No.: US 2007/0156454 A1
(43) Pub. Date: Jul. 5, 2007

(54) Biological information deleting method and system

(75) Inventor: Kimikazu Ito, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/543,067

(22) Filed: Oct. 5, 2006

(30) Foreign Application Priority Data
Jan. 5, 2006 (JP) 2006-000943

(51) Int. Cl. G06Q 10/00; G06F 19/00

(52) U.S. Cl. 705/2; 705/3

(57) ABSTRACT

The disclosed biological information deleting method and system reliably delete biological information and execute a service withdrawal process by implementing a user terminal and a member management apparatus networked together. Machine readable media have programs of instructions for executing the service withdrawal process. The member server executes the service withdrawal process upon notification of the end of the deletion of a user's biological information which is stored in either an IC card or at a user terminal.

### CROSS-REFERENCE TO RELATED APPLICATION

The present application is based on Japanese priority application No. 2006-000943 filed on Jan. 5, 2006, the entire contents of which are hereby incorporated by reference.

### BACKGROUND

The present invention relates to a system for providing services upon personal authentication by utilizing characteristics of a service user's body tissue. The invention relates particularly to a biological information deleting method and system for executing a service withdrawal process with a member management server in conjunction with the deletion of the biological information of the user when the user withdraws from services.

There has been proposed a system for providing services to a user having completed personal authentication (proof of the user's identity) by utilizing characteristics of the user's personal tissue. In this system, biological information based on the personal tissue is previously stored in an IC card and at a user terminal. A user manipulates a biological sensor that reads biological information to control the user terminal to read, for example, a palm vein image. The user terminal compares the stored biological information with the biological information of a user converted from the palm image inputted for the personal authentication. When the personal authentication is successful, the user is qualified to be connected to the member management server from the user terminal in order to receive various services. Moreover, when a user wishes to withdraw from services, the user is requested to transmit the service withdrawal request data to the member management server. Thereby, the member management server executes the service withdrawal process.

Various technologies have been proposed to delete member information and biological information stored in the member management server for the users who wish to withdraw from services.

For example, JP-A No. 2003-216781 proposes a system, in which a member number and a password of a service user are identified and the member information of a member management server is deleted upon reception of the data indicating that a user wishes to withdraw from service.

As a second example, when it is necessary to eliminate use of a system by a user when the relevant user has withdrawn from services, Registered Utility Model No. 3086892 proposes a system, in which the biological information of the user who has withdrawn from services is deleted from the member management server to disable the personal authentication.

When a user wishes to withdraw from services in a system that provides services through personal authentication by previously storing biological information to an IC card and at a user terminal, the process to withdraw from services and the process to delete biological information have been conducted independently. For example, when a user wishes to withdraw from the credit card service, the user issues a request to the credit card company for withdrawal from service. However, the user himself is requested to destroy the credit card. Moreover, in the case where biological information is stored in the user terminal, if the user desires to delete his biological information, such biological information is often stored continuously without deletion thereof even after the user has withdrawn from the service. However, with the rapid progress in technology in recent years, it has become possible to extract biological information, depending on a degree of destruction, from the IC card as well as from the user terminal. Accordingly, it is now considered that risks may have increased regarding the protection of personal information.

In the systems of the related art described above, when biological information is stored in a member management server, the relevant biological information can be deleted upon acceptance of a service withdrawal request. However, technology has not yet been disclosed for deleting the biological information when a service withdrawal request is accepted, if the biological information is stored in a place that is independent of the member management server, such as in an IC card or at a user terminal.

### SUMMARY

An object of the present invention is to provide a biological information deleting method and system for improving security with respect to the protection of personal information by executing the service withdrawal process in conjunction with the deletion of biological information of a user stored in an IC card and at a user terminal, when the user withdraws from service.

The present invention can be embodied as a system connecting, through a network, user terminal subsystems having biological information of users and a member management apparatus subsystem having member information of users. The user terminals each have a withdrawal request notifying means for notifying the member management apparatus of a withdrawal request and a biological information deletion end notifying means for notifying (indicating) the end of the deletion of the biological information. The member management apparatus has a withdrawal processing means for executing withdrawal processing of users on the basis of a notification from the biological information deletion end notifying means. With this system, it is possible to reliably delete biological information and execute the service withdrawal process by conducting first the service withdrawal process with a member server upon notification of the end of the deletion of biological information stored in the user terminal.

Moreover, the present invention can be embodied as a user terminal, in the system connecting, through a network, a user terminal having biological information of users and a member management apparatus having member information of users, characterized by including a withdrawal request notifying means for notifying the member management apparatus of a withdrawal request and biological information deletion end notifying means for notifying the end of deletion of biological information. Accordingly, a user terminal can be provided for notifying the member management apparatus of the end of the deletion of the biological information stored in the user terminal.

Moreover, the present invention can be embodied as a member management apparatus in the system connecting through a network a user terminal having biological information of users and a member management apparatus having member information of users, characterized by including a withdrawal processing means for executing withdrawal processes of users on the basis of notification of the end of deletion of the biological information. Accordingly, a member management apparatus can be provided for executing a first withdrawal process for users by receiving a notification indicating the end of the deletion of biological information stored in the user terminal.

Moreover, the present invention can be embodied as a withdrawal processing method for deleting the biological information of users stored in user terminals and executing the withdrawal process of the users. The method includes the following steps: notifying the member management apparatus of a withdrawal request, notifying the end of the deletion of biological information, and executing the withdrawal process of a user with the member management apparatus on the basis of notification of the end of deletion of the biological information. According to this method, a service withdrawal processing method can be provided for reliably deleting biological information and enabling service withdrawal processes by executing first the service withdrawal process with a member server upon reception of the notification of the end of the deletion of biological information stored in the user terminal.

The present invention can be embodied as a biological information deleting method in the method for deleting biological information of users stored in user terminals and executing a withdrawal process of users. The method includes the steps of notifying the member management apparatus of a withdrawal request, and notifying the end of the deletion of biological information. Accordingly, the biological information deleting method can be provided for notifying the member management apparatus of the end of the deletion of the biological information stored in the user terminal.

Moreover, the present invention can be embodied as a withdrawal processing method in the method for deleting biological information of users stored in a user terminal and executing the withdrawal process of users. The method includes a step of executing the withdrawal process of users on the basis of the notification of the end of the deletion of the biological information. According to this method, the withdrawal processing method can be provided for executing first the withdrawal process of users upon reception of the notification of the end of the deletion of biological information stored in the user terminal.

Moreover, the present invention can be embodied as a withdrawal processing program in the program for deleting the biological information of users stored in a user terminal and executing the service withdrawal process of the users. The program instructs the user terminal to notify the member management apparatus of a withdrawal request and the end of deletion of biological information. The program also instructs the member management apparatus to execute the withdrawal process of users on the basis of the notification of the end of the deletion of biological information. According to this program, the service withdrawal processing method program can be provided for reliably deleting biological information and executing a service withdrawal process by executing first the service withdrawal process with a member server upon reception of the notification of the end of the deletion of biological information stored in the user terminal.

Moreover, the present invention can be embodied as the biological information deleting program in the program for the deleting biological information of users stored in a user terminal and executing the service withdrawal process of the users, characterized in instructing the user terminal to notify the member management apparatus of a withdrawal request and the end of the deletion of the biological information. According to this program, a biological information deleting program can be provided for notifying the member management apparatus of the end of the deletion of the biological information stored in the user terminal.

Moreover, the present invention can be embodied as the withdrawal processing program in a program for deleting the biological information of users stored in a user terminal and executing the service withdrawal process of the users, characterized in instructing the member management apparatus to execute the withdrawal process of the users on the basis of the notification of the end of the deletion of the biological information. According to this program, a withdrawal processing program can be provided for executing the first withdrawal process of users upon reception of the notification of the end of the deletion of biological information stored in the user terminal.

The present invention can reliably delete biological information and execute a service withdrawal processes by executing first a service withdrawal process with a member server upon reception of the notification of the end of deletion of biological information of users stored in an IC card and a user terminal.

The present invention is described in detail below with reference to the accompanying drawings, which are briefly described as follows:

### BRIEF DESCRIPTION OF THE DRAWINGS

FIG. 1 is a conceptual diagram of a system according to a first embodiment of the invention;

FIG. 2 is a block diagram schematically representing an example of hardware for a member management server;

FIG. 3 is a block diagram schematically representing an example of hardware for a user terminal;

FIG. 4 is a conceptual diagram of a system according to a second embodiment of the invention;

FIG. 5 is a block diagram schematically representing a user terminal of the second embodiment;

FIG. 6 is a flowchart showing operations of a communicating unit of the user terminal;

FIG. 7 is a flowchart showing operations of a control unit of a member management server;

FIG. 8 is a flowchart showing operations of a communicating unit of the member management server;

FIG. 9 is a flowchart showing operations of the control unit of the user terminal;

FIG. 10 is a flowchart showing operations of the communicating unit of the user terminal;

FIG. 11 is a flowchart showing operations of the control unit of the member management server;

FIG. 12 is a flowchart showing operations of the communicating unit of the member management server;

FIG. 13 is a flowchart showing operations of the control unit of the user terminal;

FIG. 14 is a flowchart showing operations of the communicating unit of the member management server;

FIG. 15 is a flowchart showing operations of the control unit of the user terminal;

FIG. 16 is a table showing information registered to a member management DB;

FIG. 17 is a flowchart showing operations of the control unit of the user terminal;

FIG. 18 is a flowchart showing operations of the control unit of the user terminal;

FIG. 19 is a flowchart showing operations of the control unit of the user terminal;

FIG. 20 is a flowchart showing operations of the control unit of the user terminal;

FIG. 21 is a flowchart showing operations of the communicating unit of the user terminal;

FIG. 22 is a flowchart showing operations of the control unit of the member management server;

FIG. 23 is a flowchart showing operations of the control unit of the member management server; and

FIG. 24 is a flowchart showing operations of the control unit of the user terminal.

### DETAILED DESCRIPTION

The invention summarized above and defined by the claims below may be better understood by referring to the present detailed description, which should be read with reference to the accompanying drawings. This detailed description presents embodiments of the present invention. This description is not intended to limit the scope of claims but instead to provide examples of the invention.

In the first embodiment, biological information is stored in a user terminal 20 and a server user manipulates the user terminal 20 for authentication (proving the user's identity). Thereby, the user terminal 20 is connected to a member management server 10 to send a service withdrawal request. The member management server 10 notifies, upon reception of the service withdrawal request, the user terminal 20 of the deletion of biological information of the user stored in the user terminal 20. When the biological information of the user stored in the user terminal 20 is deleted, the member management server 10 executes a first service withdrawal process for the user.

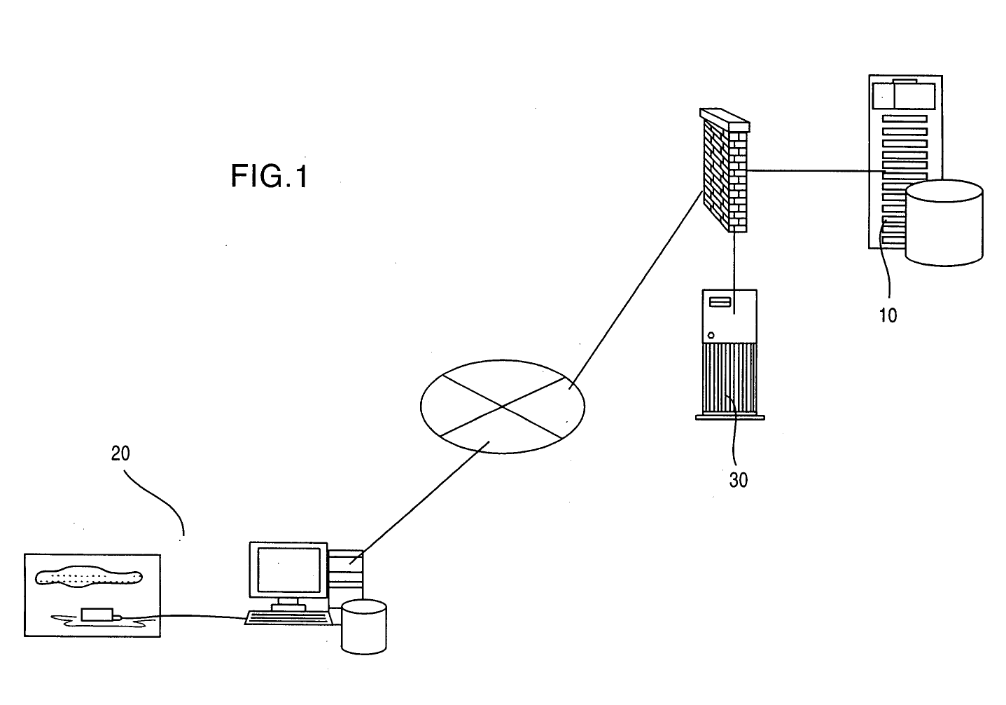

FIG. 1 is a conceptual diagram of a first embodiment of the system. The user terminal 20 used by a user is connected to the member management server 10 and a public server 30 via a network (for example, LAN, WAN, or the like). The member management server 10 stores the member information of a service user to provide various services to a user. The public server 30 is the server made public to provide pages for personal authentication for the convenience of the user to start service. Therefore, this server is provided in the DMZ (DeMilitarized Zone). When the public server 30 is allocated in the DMZ, illegal access from an external side can be eliminated with a fire wall. Even when the public server 30 is taken over, damage never extends up to the member management server 10 having important information, such as member information or the like. Moreover, the public server 30 plays the roles for extracting data from the member management server 10, transferring the relevant data to the user terminal 20 via the network, and also transferring the data transmitted from the user terminal 20 to the member management server.

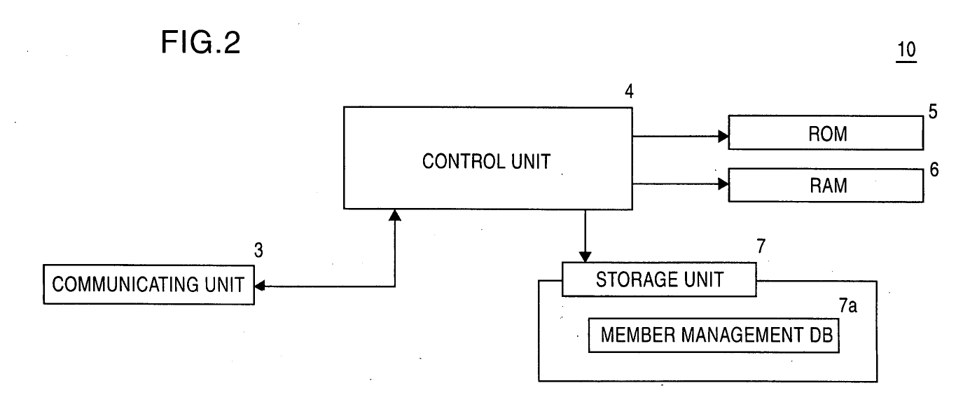

FIG. 2 is a block diagram schematically illustrating an example structure of the member management server 10. In this member management server 10, a control unit 4 is connected to a communicating unit 3 for providing a communicating function for connection with the network, a storage unit 7 including member information DB 7a storing member information of users, a ROM 5 for storing various programs such as the OS of the member management server 10 and a program for communication, and a RAM 6 used for temporarily storing information received by the communicating unit 3 for executing programs and information. The control unit 4 controls these units.

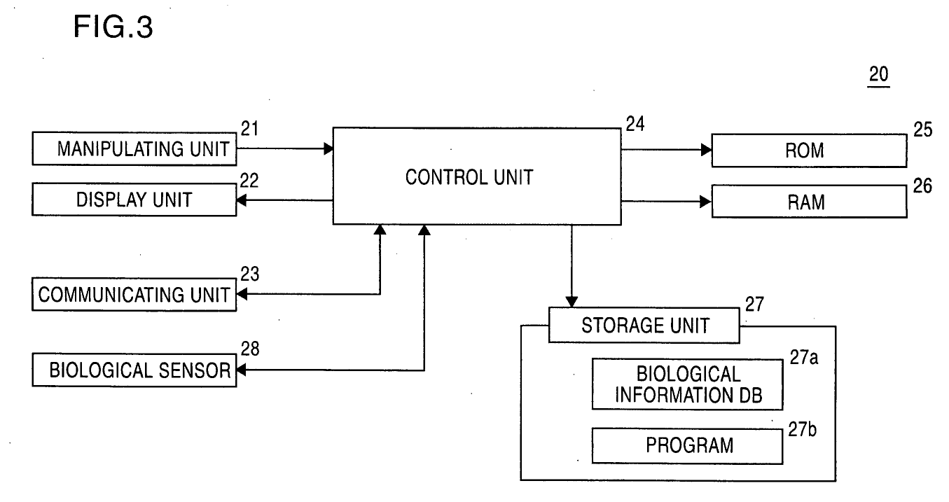

FIG. 3 is a block diagram schematically illustrating an example structure of the user terminal 20. In this user terminal 20, a control unit 24 is connected to a manipulating unit 21 with which a user inputs data or the like, a display unit 22 including a liquid crystal display screen or a CRT display screen, a communicating unit 23 for providing a communicating function for connection with the network, a tissue sensor 28 for reading the biological information of a user, a storage unit 27 including a logical information DB 27a storing biological information of users and programs 27b or the like for biological authentication, a ROM 25 for storing various programs such as the OS of the user terminal 20 and a program or the like for communication, and RAM 26 for temporarily storing program of the storage unit 27 and images read with the tissue sensor 28 for executing program and information. The control unit 24 controls these units.

The process of authenticating manipulation by a user using the user terminal 20 will now be explained.

A user connects the user terminal 20 to the public server 30 for executing the service withdrawal process. The display unit 22 of the user terminal 20 displays an authentication image for verifying the server user himself. Here, a user inputs biological information to the tissue sensor 28 for the authenticating manipulation.

Processes in the user terminal 20 will be explained.

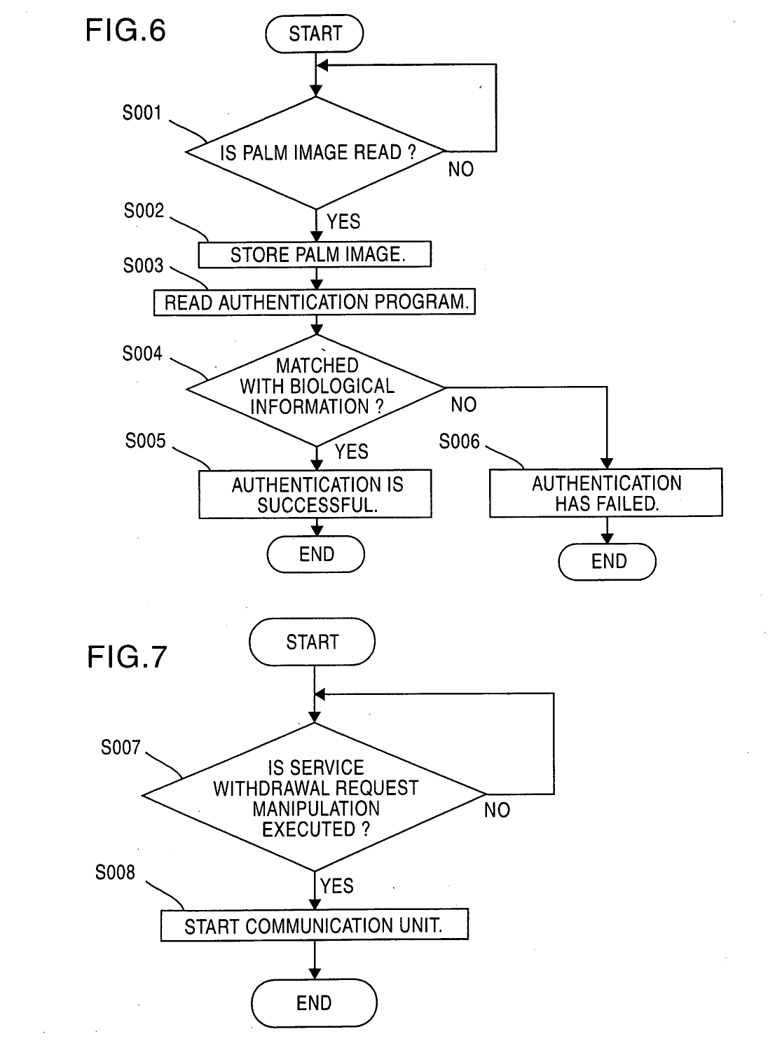

The following processes in the control unit 24 will be explained with reference to FIG. 6:

In step S001, the control unit 24 determines whether an input of a palm image of a user is notified from the tissue sensor 28. An affirmative determination suggests that the input of a palm image of a user has been notified and the process shifts to step S002. In contrast, a negative determination causes the process flow to return to step S001.

In step S002, the control unit 24 tentatively stores the palm image of the user to the RAM 26. The process then shifts to step S003.

In step S003, the control unit 24 inputs to the RAM 26 an authentication program for determining whether the palm image of the user matches biological information stored in the biological information DB 27a of the storage unit 27. The process then shifts to step S004.

In step S004, the control unit 24 executes the authenticating program inputted in step S003. Accordingly, the authenticating program converts the palm image of a user into biological information to determine whether the relevant converted biological information matches the biological information stored in the biological information DB 27a. An affirmative determination suggests that the biological information converted from the palm image of a user matches biological information stored in the biological information DB 27a. Therefore, the process flow shifts to step S005. In contrast, a negative determination shifts the process flow to step S006.

In step S005, the control unit 24 displays a successful authentication on the display unit 22. Since the authentication is successful, a user is capable of transmitting the service withdrawal request data for requesting withdrawal from service to the member management server 10 from the user terminal 20. At this point, the process is completed.

In step S006, the control unit 24 displays a failed authentication on the display unit 22 to urge a user to execute again the authenticating manipulation. A user executes, as required, again the authenticating manipulation. At this point, the process is completed.

The following processes in the control unit 24 will be explained with reference to FIG. 7:

In step S007, the control unit 24 determines whether it is notified from the manipulating unit 21 that manipulation for a service withdrawal request has been executed. An affirmative determination suggests a notification that manipulation for service withdrawal has been conducted. Accordingly, the process flow shifts to step S008. In contrast, a negative determination causes the process flow to return to step S007.

In step S008, the control unit 24 activates the communicating unit 23 for transmitting the service withdrawal request data to the member management server 10. At this point, the process is completed.

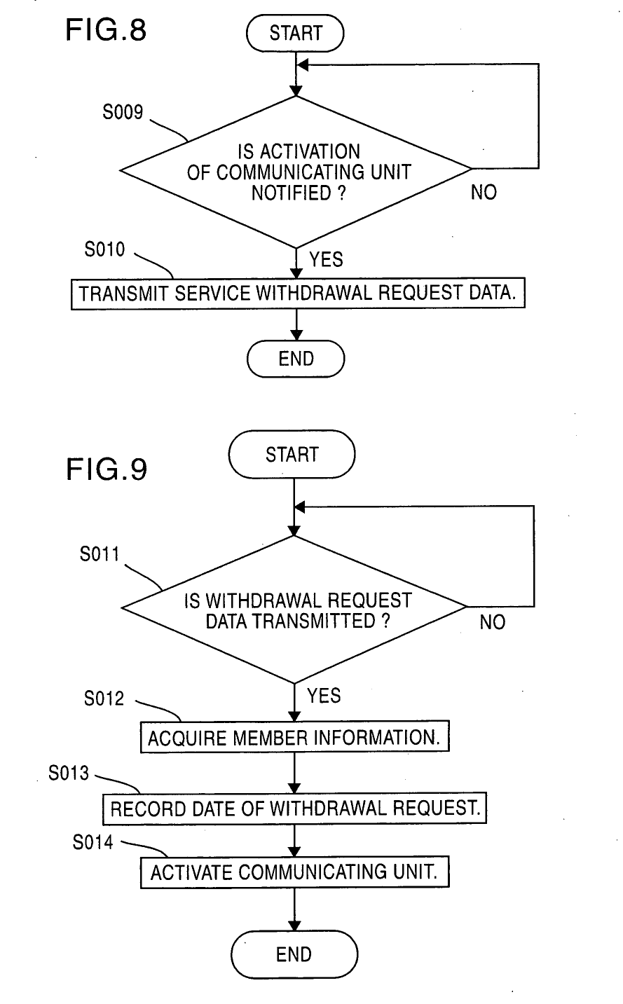

Processes in the communicating unit 23 will be explained with reference to FIG. 8.

In step S009, the communicating unit 23 determines whether activation is notified from the control unit 24. An affirmative determination suggests that an activation has been made. Therefore, the process shifts to step S010. In contrast, a negative determination causes the process flow to return to step S009.

In step S010, the communicating unit 23 transmits the service withdrawal request data to the member management server 10 via the Network. The service withdrawal request data includes information pieces such as user ID and user name or the like and the member management server 10 acquires member information of a withdrawal requesting user from the member management DB 7a with reference to the relevant information. These processes will be explained later. At this point, the process is completed.

The process will now be explained for which the member management server 10 acquires the member information of a withdrawal requesting person with reference to the service withdrawal request data transmitted from the user terminal 20, records the withdrawal request date in the member management DB 7a, and notifies a user of the acceptance of the withdrawal request.

Processes executed by the member management server 10 will now be explained.

The process executed by the control unit 4 will be explained with reference to FIG. 9.

In step S011, the control unit 4 determines whether it has been notified by the communicating unit 3 that the service withdrawal request data has been transmitted from the communication unit 23 of the user terminal 20. An affirmative determination causes the process flow to shift to step S012, because it has been notified that the service withdrawal request data has been transmitted. In contrast, a negative determination causes the process flow to return to step 011.

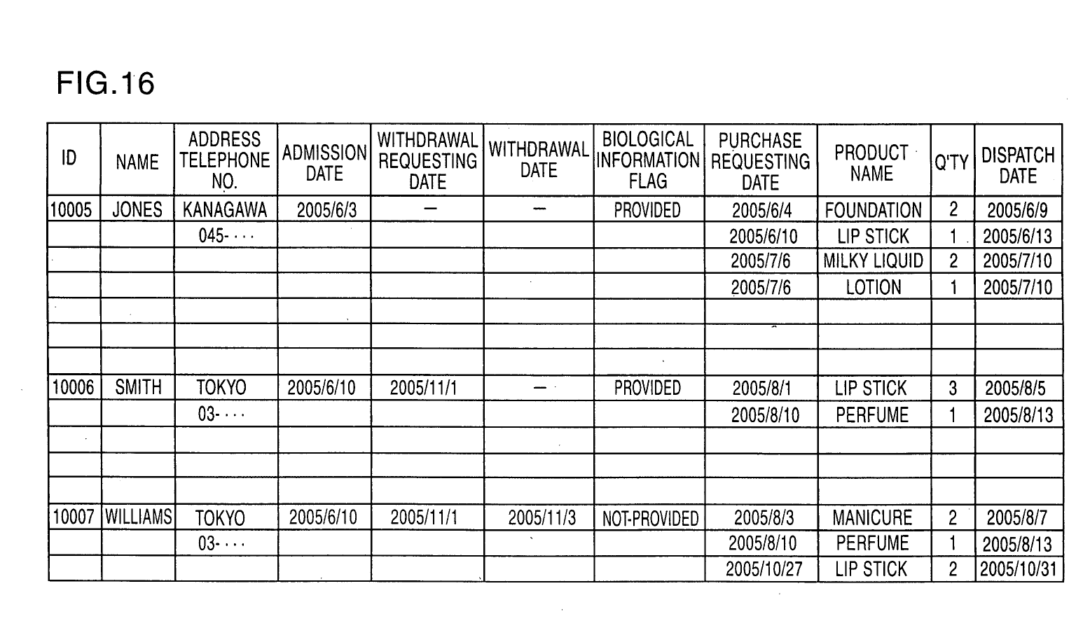

In step S012, the control unit 4 acquires the member information of the withdrawal requesting person from the member management DB7a with reference to the user ID or the like in the service withdrawal request data. The member management DB7a stores, as illustrated in FIG. 16, the member ID, name, purchase history or the like. One item indicates the existence or non-existence of a biological information flag. This biological information flag indicates whether the biological information that was stored in the user terminal 20 has been deleted or not. For example, the data indicates that the user having ID10007 has completed the withdrawal process, because the biological information flag is recorded as “not provided” and the withdrawal date is also recorded. The data also indicates that the user having ID10006 has not yet completed the withdrawal process, because the biological information flag is recorded as “provided” and the biological information stored in the user terminal 20 is not yet deleted, although the withdrawal request date is recorded. Moreover, it can also be understood that the user having ID1005 still continues reception of services, because no withdrawal request date is recorded and the biological information flag is recorded as “provided”. The process shifts to step S013.

In step S013, the control unit 4 enters the date that the withdrawal request was accepted as the withdrawal request date item of the member information for the user who is requesting service withdrawal of the member management DB7a. The process shifts to step S014.

In step S014, the control unit 4 activates the communicating unit 3 for notifying the user of acceptance of the service withdrawal request. At this point, the process is completed.

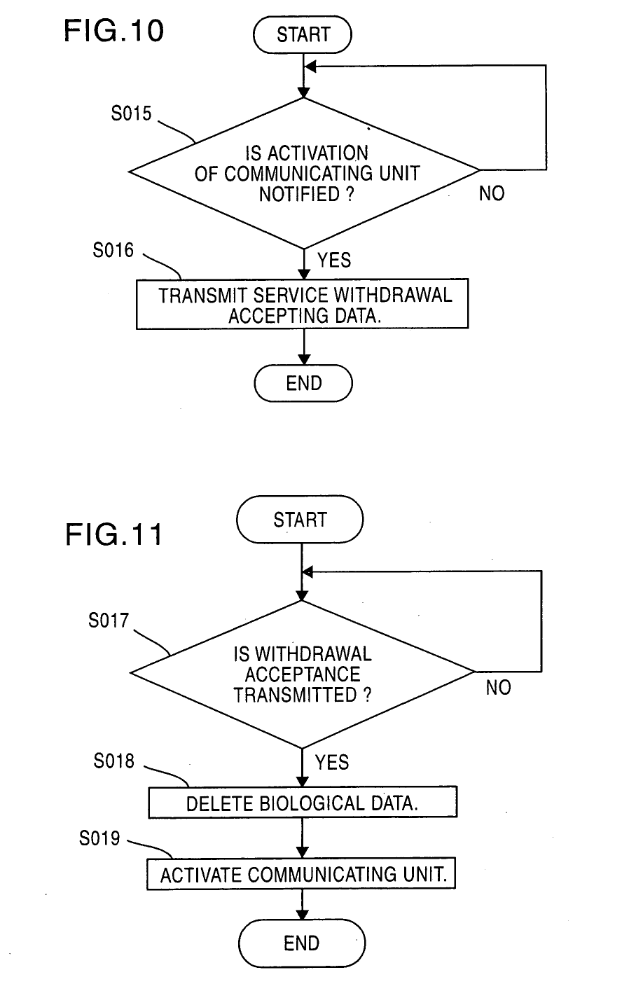

Processes executed by the communicating unit 3 will now be explained with reference to FIG. 10.

In step S015, the communicating unit 3 determines whether activation has been notified from the control unit 4. An affirmative determination causes the process flows to shift to step S016, because activation is notified. In contrast, a negative determination causes the process flow to return to step S015.

In step S016, the communicating unit 3 transmits the service withdrawal accepting data for notifying the user terminal 20 of acceptance of the service withdrawal request. At this point, the process is completed.

The process that the user terminal 20 receives the service withdrawal accepting data from the member management server 10 and deletes the biological information stored therein will now be explained.

Processes in the user terminal 20 will be explained as follows:

Regarding processes in the control unit 24, reference is made to FIG. 11.

In step S017, the control unit 24 determines whether it has been notified from the communicating unit 23 that the service withdrawal accepting data has been transmitted from the communicating unit 3 of the member management server 10. An affirmative determination causes the process flows to shift to step S108, because the communicating unit 3 of the member management server 10 indicated that service withdrawal accepting data has been transmitted. In contrast, a negative determination causes the process flow to return to step S017.

In step S108, the control unit 24 deletes the biological information stored in the biological information DB27a of the storage unit 27. As the method for deleting biological information, the control unit 24 enters, for example, “1” to the information of the biological information DB27a. When the control unit 24 reads again the information of the biological information DB27a and “1” is for all information, it is recognized as the end of deletion of the biological information. The process shifts the step S019.

In step S019, the control unit 24 activates the communicating unit 23, because deletion of the biological information stored in the user terminal 20 is notified to the member management server 10. At this point, the process is completed.

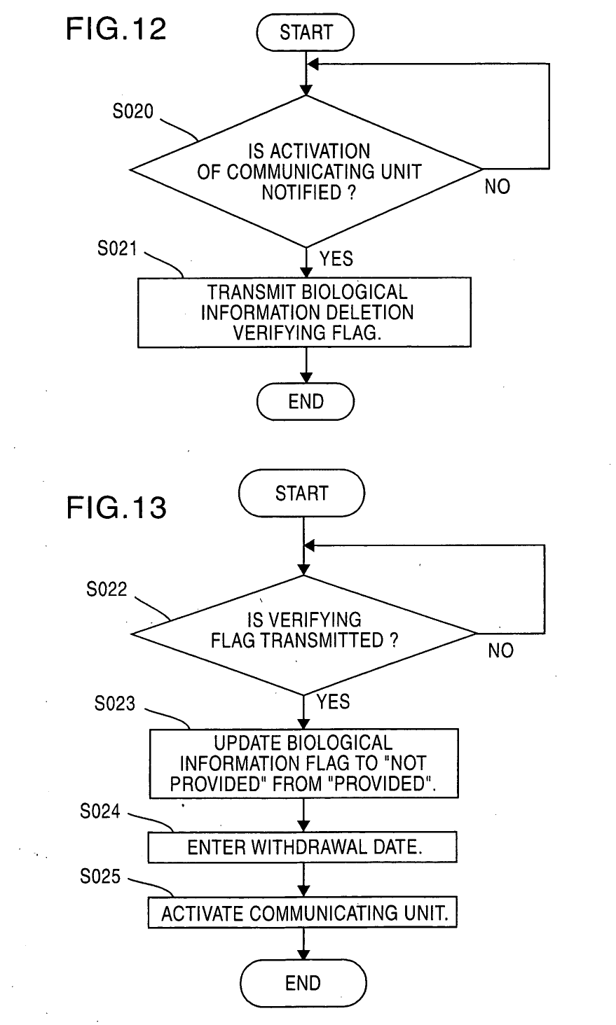

Processes in the communicating unit 23 will be explained with reference to FIG. 12.

In step S020, the communicating unit 23 determines whether activation is notified from the control unit 24 or not. An affirmative determination causes the process flow to shift to step S020, because activation has been notified. In contrast, a negative determination causes the process flow to return to step S020.

In step S021, the communicating unit 23 transmits, via the Network, the biological information deletion verifying flag for notifying the member management server 10 of the deletion of the biological information of the user terminal 20. At this point, the process is completed.

The process will now be explained in which the member management server 10 receives the biological information deletion verifying flag from the user terminal 20, updates the biological information flag of the relevant member information in the member management DB7a to “not provided” from “provided”, and notifies a user of completion of the withdrawal process.

The process in the member management server 10 will be explained as follows:

Regarding the process in the control unit 4, reference is made to FIG. 13.

In step S022, the control unit 4 determines whether it has been notified from the communicating unit 3 that the biological information deletion verifying flag is transmitted from the communicating unit 23 of the user terminal 20. An affirmative determination causes the process flow to shift to step S023, because transmission of the biological information deletion verifying flag is notified from the communication unit 23 of the user terminal 20. In contrast, a negative determination causes the process return to step S022.

In step S023, the control unit 4 updates the item of the biological information flag of the member information of the relevant user of the member management DB7 to “not provided” from “provided”. The process flow then shifts to step S024.

In step S024, the control unit 4 enters the date of completion of the withdrawal process into the item of the withdrawal date of the member information of the relevant user of the member management DB7. The process shifts to step S025, whereby the service provider can detect the period or the like in which the user having completed the withdrawal process has received the services from the record of the admission date and withdrawal date.

In step S025, the control unit 4 activates the communicating unit 3 to notify a user of the completion of the withdrawal process. At this point, the process is completed.

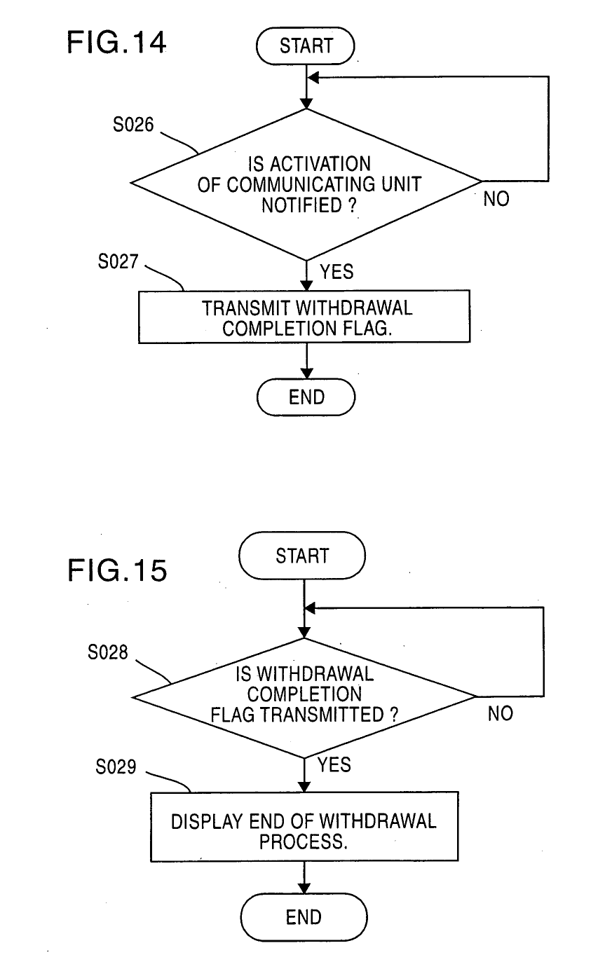

The process in the communicating unit 3 will be explained with reference to FIG. 14.

In step S026, the communicating unit 3 determines whether activation is notified from the control unit 4. An affirmative determination causes the process to shift to step S027, because activation has been notified. In contrast, a negative determination causes the process flow to return to step S026.

In step S027, the communicating unit 3 transmits, via the Network, the withdrawal process completion flag to the user terminal 20 in order to notify the end of withdrawal process. At this point, the process is completed.

The process in the control unit 24 will be explained with reference to FIG. 15.

In step S028, the control unit 24 determines whether it has been notified from the communicating unit 23 that the withdrawal process completion flag is transmitted from the communicating unit 3 of the member management server 10. An affirmative determination causes the process flow to shift to step S029, because transmission of the withdrawal process completion flag is notified from the communicating unit 3 of the member management server 10. In contrast, a negative determination causes the process flow to return to step S028.

In step S029, the control unit 24 displays on the display unit 22 that the withdrawal process has been completed whereby a user can detect the end of service withdrawal process. At this point, the process is completed.

### SECOND EMBODIMENT

The first embodiment explains that biological information of a user is stored in a user terminal 20 and a user executes authentication manipulation using a biological sensor 28 and also executes service withdrawal procedures. However, authentication manipulation using biological information of a user obtained from means other than the biological sensor 28 may be utilized. For example, a user card is incorporated as a part of the system.

In the second embodiment, a user executes authentication manipulations using a user card, such as an IC card storing biological information and also executes service withdrawal request procedures.

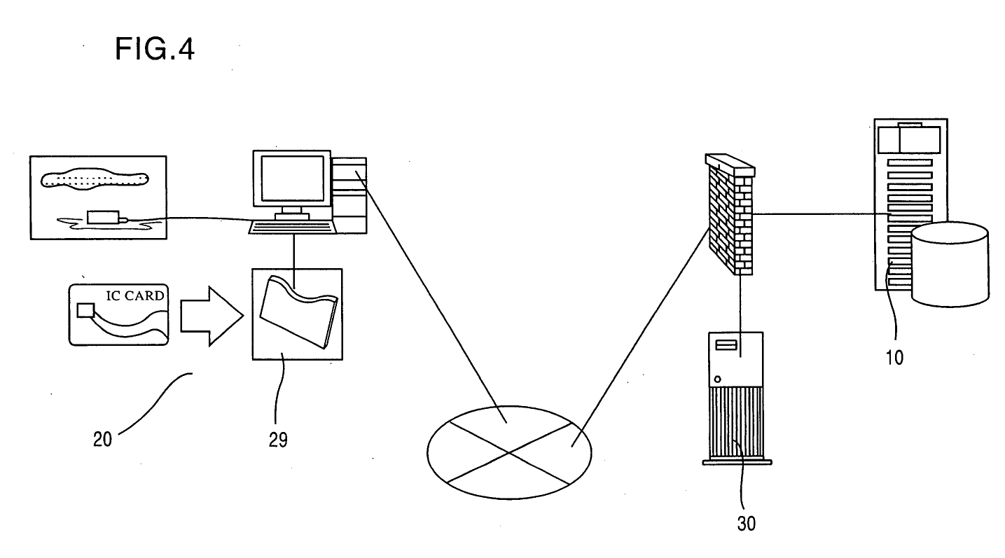

FIG. 4 illustrates the concept of a system in accordance with a second embodiment of the invention. The user terminal 20 to be used by a user is connected with the member management server 10 and public server 30 via a network. Roles and structures of the member management server 10 and public server 30 are identical to that in the first embodiment.

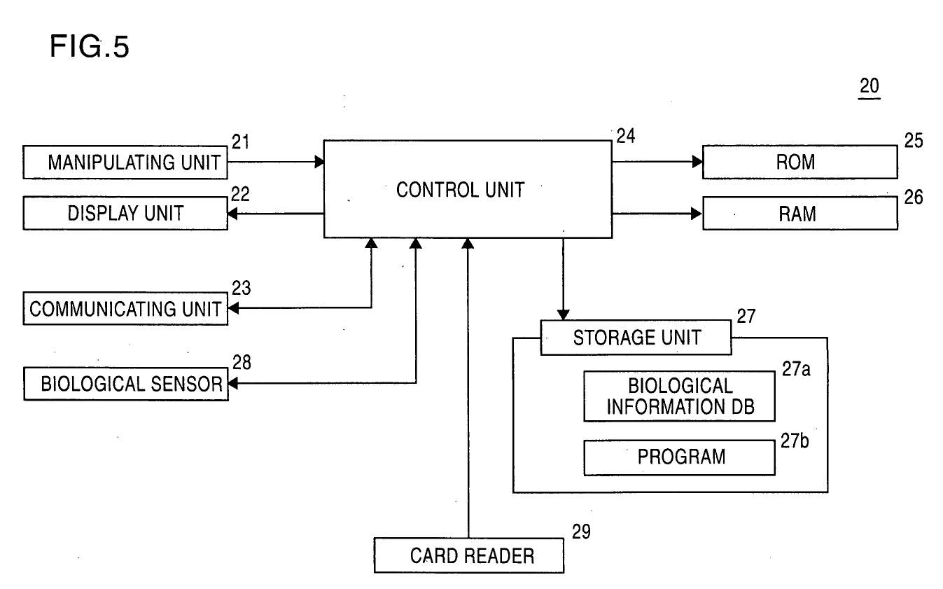

FIG. 5 is a block diagram schematically illustrating an example of the structure of the user terminal 20. In the user terminal 20, the control unit 24 is connected to the manipulating unit 21 with which a user inputs data, the display unit 22 including liquid crystal display screen and display screen of CRT, the communicating unit 23 for providing communicating function for connection with the network, the biological sensor 28 for reading biological information of user, a card reader 29 with which a user can control the user terminal to read an IC card, the biological information DB27a storing biological information of a user, the storage unit 27 including a program 27b or the like for biological authentication, the ROM25 for storing OS of the user terminal 20 and various programs such as the program for communication, and the RAM26 for tentatively storing programs of the storage unit 27, data read from an IC card through the card reader 29 and images read with the biological sensor 28 and is used to execute the programs and to process information pieces. The control unit 24 controls each of these devices.

The system operations with respect to the second embodiment will be explained with reference to the drawings. The second embodiment 2 differs from the first embodiment regarding a process of reading biological information from the newly added card reader 29 with the control unit 24 and the process of deleting the biological information stored in the IC card. Accordingly, these processes points will now be explained.

Explained first is the process in which a user executes the authentication process using the user terminal.

A user connects to the public server 30 from the user terminal 20 for withdrawal from service. The authentication format to verify a service user is displayed on the display unit 22 of the user terminal 20. Here, the user instructs the card reader 29 of the user terminal 20 to read the IC card. The user executes the authentication manipulation by inputting the biological information to the biological sensor 28.

Processes in the user terminal 20 will now be explained.

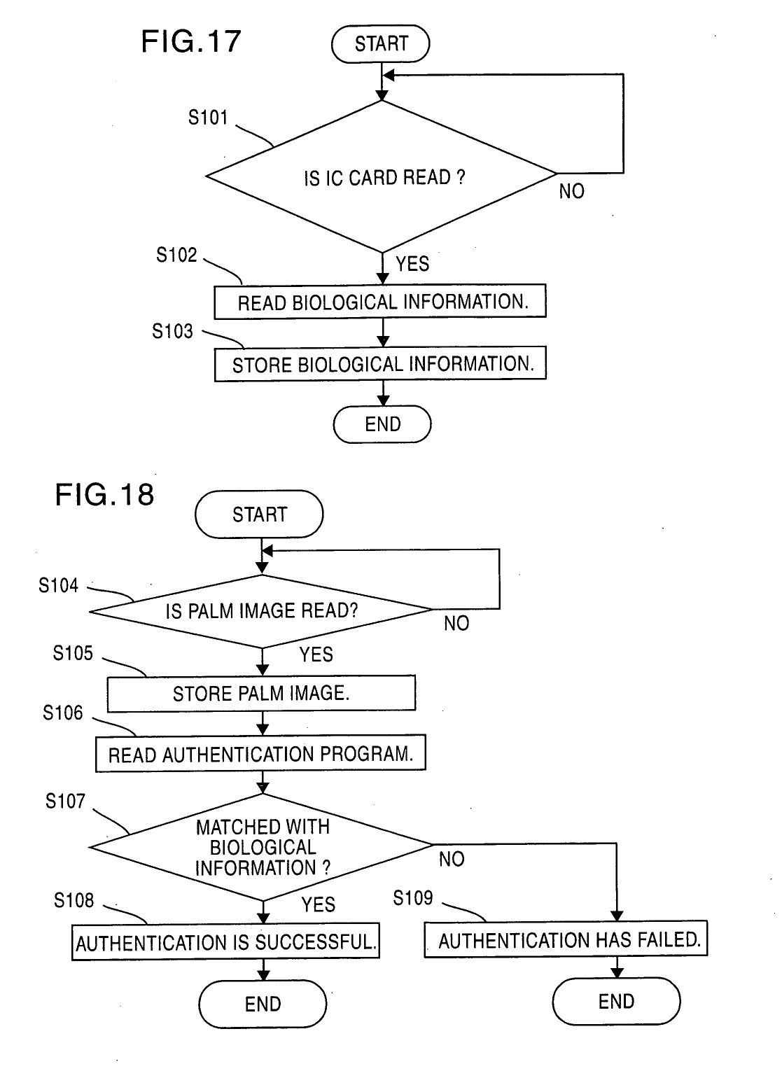

Regarding the process in the control units 24, reference is made to FIG. 17.

In step S101, the control unit 24 determines whether it is notified from the card reader 29 that the IC card of a user has been read. An affirmative determination causes the process flow to shift to step S102, because it is notified that the IC card of a user is read. In contrast, a negative determination causes the process flow return to step S101.

In step S102, the control unit 24 reads the biological information of the user from the IC card. The process shifts to step S103.

In step S103, the control unit 24 temporarily stores in the RAM 26 the biological information of the user read in step S102. At this point, the process is completed.

The process in the control unit 24 will be explained with reference to FIG. 18.

In step S104, the control unit 24 determines whether it is notified that a palm image of a user is read from the biological sensor 28. An affirmative determination causes the process flow to shift to step S105, because it is notified that the palm image of user is read. In contrast, a negative determination causes the process flow to return to step S104.

In step S105, the control unit 24 temporarily stores the palm image of the user in the RAM26. The process then shifts to step S106.

In step S106, the control unit 24 reads and transfers to the RAM 26 from the program 27b of the storage unit 27 the authentication program for determining whether the palm image of user is matched with the biological information stored in the biological information DB 27a of the storage unit 27. The process then shifts to step S107.

In step S107, the control unit 24 executes the authentication program read in step S106. Accordingly, the authentication program converts the palm image of the user into biological information and determines whether the relevant converted biological information is matched with biological information stored in the RAM26 in step S103. An affirmative determination causes the process flow to shift to step S108, because the biological information converted from the palm image of the user is matched with the biological information stored in the RAM 26. In contrast, a negative determination causes the process flow to shift to step S109.

In step S108, the control unit 24 displays on the display unit 22 that authentication is completed successfully. When the authentication is successful, the user is capable of transmitting, from the user terminal 20, the service withdrawal request data for requesting withdrawal from service to the member management server 10. The process is then completed.

In step S109, the control unit 24 displays on the display unit 22 that authentication has failed and urges the user to execute again the authentication manipulation. The user executes again the authentication manipulation as desired. The process is then completed.

The processes in which the user terminal 20 receives the service withdrawal accepting data from the member management server 10 and in which the biological information stored in the IC card is deleted will now be explained.

The process in the user terminal 20 is explained as follows:

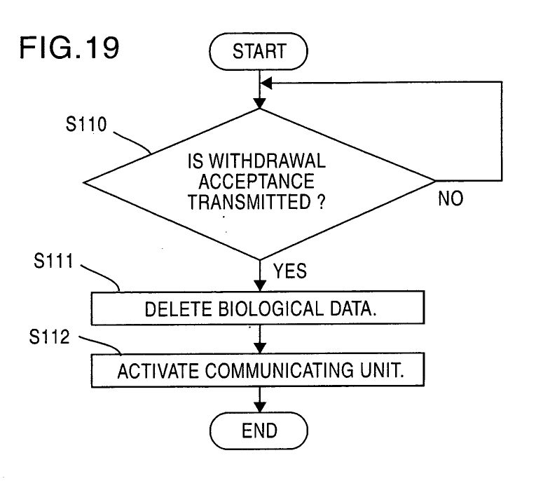

The process in the control unit 24 will be described with reference to FIG. 19.

In step S110, the control unit 24 determines whether it is notified from the communicating unit 23 that service withdrawal accepting data is transmitted from the communicating unit 3 of the member management server 10. An affirmative determination causes the process flow to shift to step S111, because the service withdrawal accepting data are transmitted from the communicating unit 3 of the member management server 10. In contrast, a negative determination causes the process flow to return to step S110.

In step S111, the control unit 24 deletes the biological information stored in the IC card. To delete the biological information, the control unit 24 enters, for example, “1”, into the biological information of the IC card. The control unit 24 reads again the information in the IC card. When “1” is written, it is recognized as the end of the deletion of the biological information. The process flow shifts to step S112.

In step S112, the control unit 24 activates the communicating unit 23 to notify the member management server 10 of the deletion of the biological information stored in the IC card. The process is then completed.

### THIRD EMBODIMENT

In the second embodiment, a user executes authentication manipulation using an IC card storing biological information and also executes the service withdrawal request procedures. However, it may also be assumed that biological information is not deleted because of certain trouble, such as that the user has removed the card from the card reader 29 before the end of the deletion of the biological information.

The following discussion of a third embodiment of the invention will cover operations of the system in which the deletion of biological information is interrupted (discussed above) and thereby deletion of biological information is incomplete.

The process will now be described in which the user terminal 20 receives service withdrawal accepting data from the member management server 10 and then deletes the biological information stored in the IC card.

The process executed in the user terminal 20 will be explained as follows:

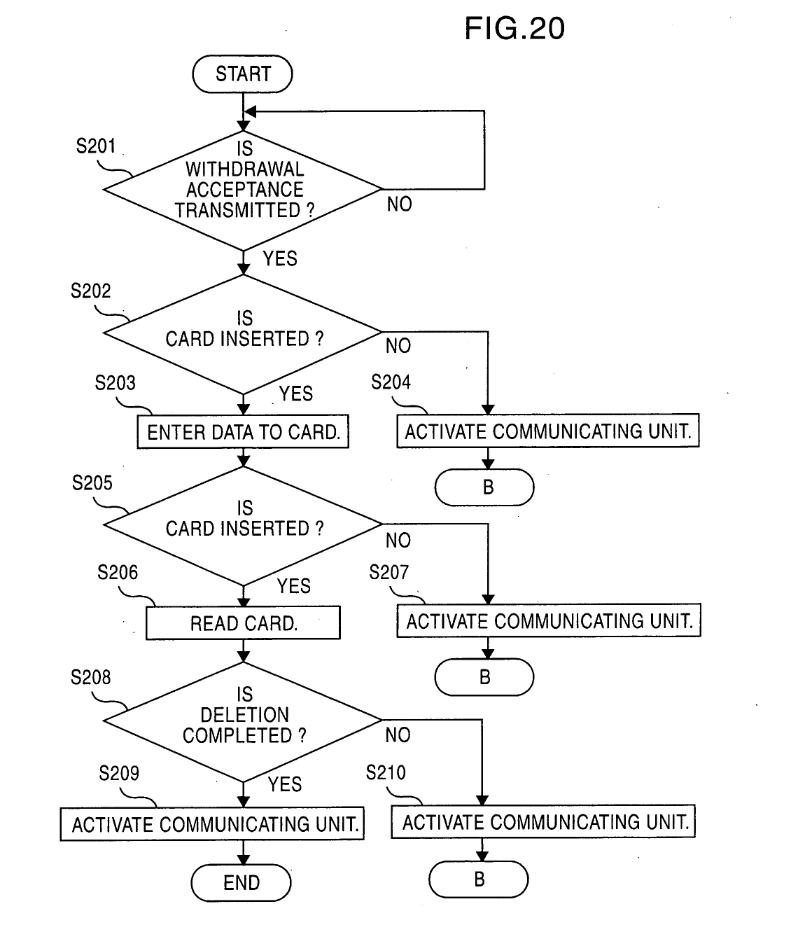

The process executed in the control unit 24 is explained with reference to FIG. 20.

In step S201, the control unit 24 determines whether it has been notified from the communicating unit 23 that the service withdrawal accepting data is transmitted from the communicating unit 3 of the member management server 10. An affirmative determination causes the process flow to shift to step S202, because transmission of the service withdrawal accepting data is notified from the communicating unit 3 of the member management server 10. In contrast, a negative determination causes the process flow to return to step S201.

In step S202, the control unit 24 determines whether the card is inserted into the card reader 29. This determination is necessary, because biological information cannot be deleted when the card is not inserted. An affirmative determination causes the process flow to shift to step S203, because the card is inserted into the card reader. In contrast, a negative determination causes the process flow to shift to step S204.

In step S203, the control unit 24 enters “1” to the biological information stored in the card. The process shifts to step S205.

In step S204, the control unit 24 activates the communicating unit 23 to notify the member management server 10 of a disabled deletion of the biological information stored in the card. At this point, the process is completed.

In step S205, the control unit 24 determines whether the card is inserted into the card reader 29. If the card is not inserted, the deletion of biological information cannot be verified. An affirmative determination causes the process flow to shift to step S206, because the card is inserted into the card reader 29. In contrast, a negative determination causes the process flow to shift to step S207.

In step S206, the control unit 24 reads the information in the card. The process then shifts to step S208.

In step S207, the control unit 24 causes the communicating unit 23 to notify the member management server 10 of the disabled verification of the deletion of the biological information stored in the card. The process is the completed.

In step S208, the control unit 24 determines whether “1” is entered in each of the information segments obtained. An affirmative determination causes the process flow to shift to step S209, because “1” is entered in all information segments. In contrast, a negative determination causes the process flow to shift to step S210.

In step S209, the control unit 24 activates the communicating unit 23 to notify the member management server 10 of the deletion of the biological information stored in the card. The process is then completed.

In step S210, the control unit 24 activates the communicating unit 23 to notify the member management server 10 of the disabled deletion of biological information stored in the card. The process is then completed.

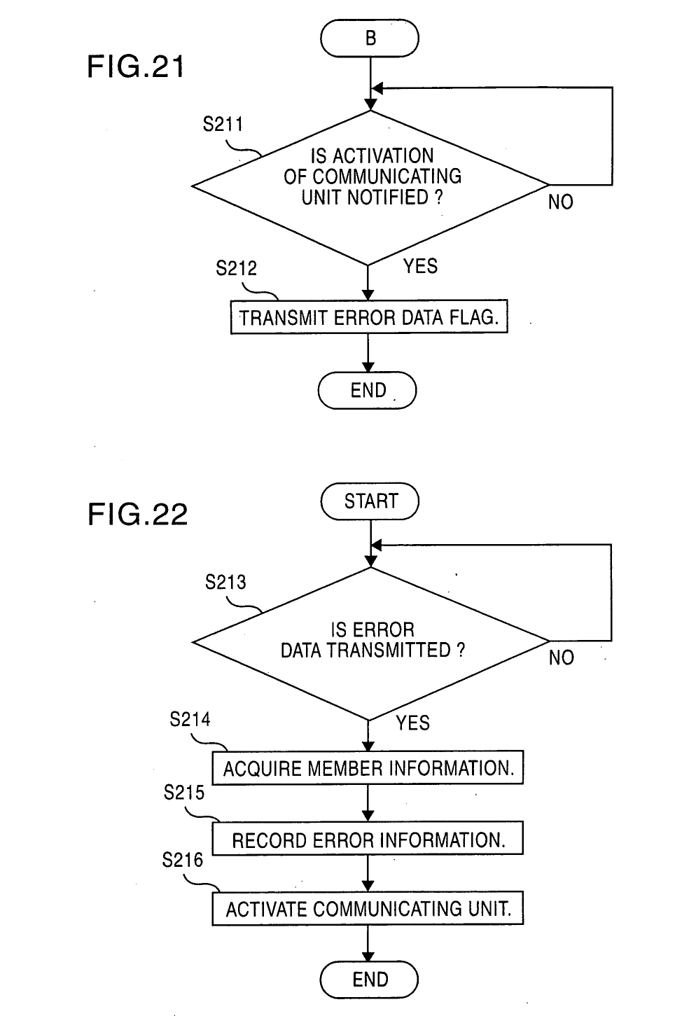

The process in the communicating unit 23 will be explained with reference to FIG. 21. In step S211, the communicating unit 23 determines whether activation is notified from the control unit 24. An affirmative determination causes the process flow to shift to step S212, because activation has been notified. In contrast, a negative determination causes the process flow to return to step S211.

In step S212, the communicating unit 23 transmits, via the Network, an error data flag for notifying the member management server 10 of the disabled verification of the end of the deletion of the biological information stored in the card. The error data flag includes information such as user ID and name or the like. The member management server 10 acquires, from the member management DB 7a, the member information of the withdrawal requesting user for whom the end of deletion of the biological information could not be verified. These processes will be explained later. The process described in FIG. 21 is now completed.

The process will now be explained in which the member management server 10 acquires the member's information of the withdrawal requesting user with reference to the error data flag transmitted from the user terminal 20, records error information in the member management DB 7a, and notifies the user terminal 20 of the disabled verification of the deletion of biological information.

The process in the member management server 10 is explained as follows:

The process in the control unit 4 will be explained with reference to FIG. 22.

In step S213, the control unit 4 determines whether it is notified from the communicating unit 3 that the error data flag is transmitted from the communicating unit 23 of the user terminal 20. An affirmative determination causes the process flow to shift to step S214, because it is notified that the error data flag has been transmitted. In contrast, a negative determination causes the process flow to return to step S213.

In step S214, the control unit 4 acquires the member information of the withdrawal requesting user, for whom deletion of the biological information could not be verified, from the member management DB 7a with reference to the user ID or the like of the error data flag. The process then shifts to step S215.

In step S215, the control unit 4 enters that the deletion of biological information could not be verified into the member information of the user for whom the deletion of the biological information into the member management DB 7a could not be verified. The process then shifts to step S216.

In step S216, the control unit 4 activates the communicating unit 3 to transmit, to the user, an error data existing flag to send disabled verification of the deletion of the biological information. The process is then completed.

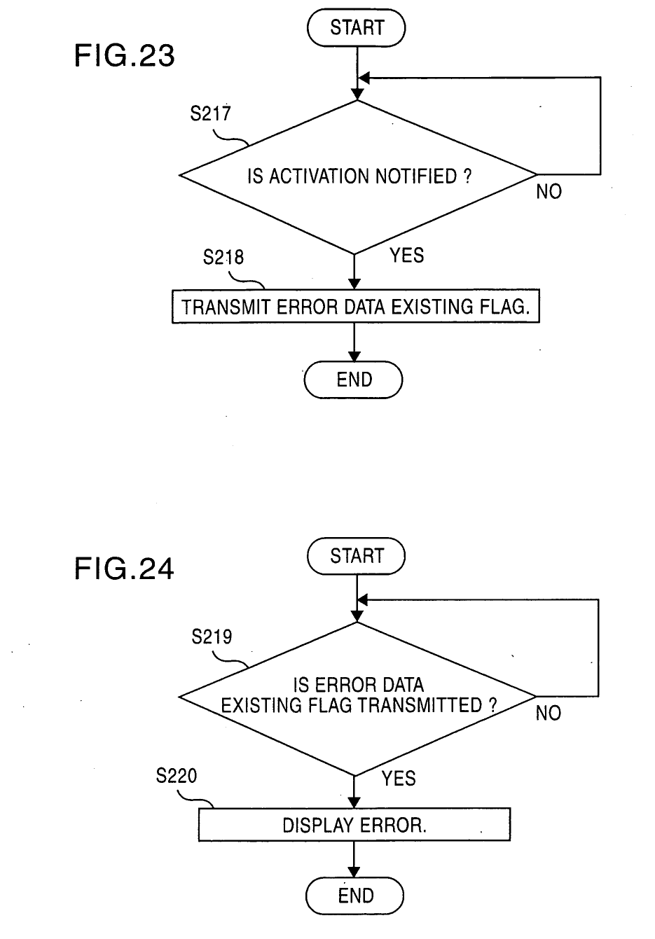

The process in the communicating unit 3 will now be explained with reference to FIG. 23.

In step S217, the communicating unit 3 determines whether activation is notified from the control unit 4. An affirmative determination causes the process flow to shift to step S218, because activation has been notified. In contrast, a negative determination causes the process flow to return to step S217.

In step S218, the communicating unit 3 transmits the error data existing flag to the user terminal 20. The process is now completed.

The process in the user terminal 20 will now be explained. The process in the control unit 24 is explained with reference to FIG. 24.

In step S219, the control unit 24 determines whether it is notified from the communicating unit 23 that the error data existing flag has been transmitted from the communicating unit 3 of the member management server 10. An affirmative determination causes the process flow to shift to step S220, because it is notified that the error data existing flag is transmitted from the communicating unit 3 of the member management server 10. In contrast, a negative determination causes the process flow to return to step S219.

In step S220, the control unit 24 displays on the display unit 22 that the withdrawal process is not yet completed, because deletion of biological information is not verified. The process is now completed.

Accordingly, a user can detect that the deletion of biological information stored in the card is not yet verified. As explained above, if the deletion of biological information cannot be completed because of certain trouble, it is possible to urge a user to complete the deletion of biological information by introducing the structure to execute first the withdrawal process, upon completion of deletion of biological information. Thereby, leak of biological information to a third party from the card and user terminal can be prevented.

Having thus described exemplary embodiments of the invention, it will be apparent that various alterations, modifications, and improvements will readily occur to those skilled in the art. Alterations, modifications, and improvements of the disclosed invention, though not expressly described above, are nonetheless intended and implied to be within spirit and scope of the invention. Accordingly, the foregoing discussion is intended to be illustrative only; the invention is limited and defined only by the following claims and equivalents thereto.

What is claimed is:

1. A system for deleting biological information, said system comprising:
a withdrawal request means for requesting a withdrawal from a service;
a biological information deletion means for deleting biological information stored in the system;
a biological information deletion end notifying means for notifying a subsystem that the biological information has been deleted; and
a withdrawal processing means for executing a withdrawal process for users on the basis of a notification from said biological information deletion end notifying means.

2. A system for deleting biological information, said system comprising:
a user terminal; and
a member management apparatus;
wherein said user terminal has a withdrawal request notifying means for notifying said member management apparatus of a withdrawal request and a biological information deletion end notifying means for notifying said member management apparatus of the end of the deletion of said biological information, and
wherein said member management apparatus has a withdrawal processing means for executing a withdrawal process for users on the basis of a notification from said biological information deletion end notifying means.

3. The system for deleting biological information according to claim 2,
wherein said user terminal has a storage unit for storing biological information of users, and
wherein said user terminal has a biological deletion means for deleting said biological information of users stored on said storage unit on the basis of a notification received from said member management apparatus instructing the deletion of said biological information.

4. The system for deleting biological information according to claim 2,
wherein said user terminal has a card reader for a user card which stores biological information of the user, and
wherein said user terminal has a biological deletion means for deleting said biological information of the user stored on said user card on the basis of a notification received from said member management apparatus instructing the deletion of said biological information.

5. The system for deleting biological information according to claim 2,
wherein said member management has a biological information deletion request means, and
wherein said user terminal has a biological deletion means for deleting said biological information on the basis of a notification from said biological information deletion request means.

6. A user terminal for connecting to a member management apparatus, said user terminal comprising:
a withdrawal request notifying means for notifying said member management apparatus of a withdrawal request; and
a biological information deletion end notifying means for deleting said biological information on the basis of a notification instructing the deletion of said biological information from received said member management apparatus and for notifying to said member management apparatus the end of the deletion of said biological information to instruct said member management apparatus to execute a withdrawal process.

7. The user terminal according to claim 6,
wherein said user terminal has a storage unit for storing biological information of users, and
wherein said user terminal has a biological deletion means for deleting said biological information of users stored on said storage unit on the basis of a notification received from said member management apparatus instructing the deletion of said biological information.

8. The user terminal according to claim 6,
wherein said user terminal has a card reader for a user card which stores biological information of the user, and
wherein said user terminal has a biological deletion means for deleting said biological information of users stored on said user card on the basis of a notification received from said member management apparatus instructing the deletion of said biological information.

9. The user terminal according to claim 6,
wherein said user terminal has a biological deletion means for deleting said biological information on the basis of a notification from a biological information deletion request means of said member management apparatus.
